(19) United States
(12) Patent Application Publication
(10) Pub. No.: US 2026/0138920 A1
(43) Pub. Date: May 21, 2026

(54) HYDRATED SODIUM SILICATE ALUMINATE AS AN ACCELERATOR FOR SPRAYED CONCRETE

(71) Applicant: PQ LLC, Malvern, PA (US)

(72) Inventors: Michael McDonald, Toronto (CA); Daoping Guo, Ontario (CA); Wieslawa Sidorkiewicz, Ontario (CA); Ava Grace Maffei, Homer Glen, IL (US)

(73) Assignee: PQ LLC, Malvern, PA (US)

(21) Appl. No.: 19/450,903

(22) Filed: Jan. 16, 2026

Related U.S. Application Data
(63) Continuation-in-part of application No. 19/268,140, filed on Jul. 14, 2025.
(60) Provisional application No. 63/672,794, filed on Jul. 18, 2024.

(51) Int. Cl. C04B 22/00; C04B 18/02; C04B 28/12

(52) U.S. Cl. CPC C04B 22/0093; C04B 18/02; C04B 28/12

(57) ABSTRACT

Embodiments relate to the development of accelerators, and specifically to hydrated silicate aluminate accelerators. The accelerators can be blended with cement-containing compositions to form shotcrete (e.g., sprayed concrete) mixtures. The accelerators have improved properties over conventional sodium silicate accelerators, offering early strength development of shotcrete while maintaining or improving long-term strength.

### CROSS-REFERENCE TO RELATED APPLICATIONS

This patent application is a continuation-in-part application of U.S. application Ser. No. 19/268,140, filed on Jul. 14, 2025, which is related to and claims the benefit of priority of U.S. Provisional Application 63/672,794, filed on Jul. 18, 2024, the entire contents of which are incorporated by reference.

### FIELD

Embodiments relate to silicate-based accelerators enriched with aluminum-based compounds, hydrated silicate aluminate accelerators, and methods of making and using thereof. The accelerators can be blended with cement-containing compositions to form shotcrete (e.g., sprayed concrete) mixtures. The accelerators have improved properties over conventional sodium silicate accelerators, offering early strength development of shotcrete while maintaining or improving long-term strength.

### BACKGROUND

Shotcrete, also referred to as sprayed concrete, is widely used in mining, tunnelling, structural rehabilitation, slope stabilization and other geotechnical and civil engineering applications. The process involves pneumatically spraying a mixture of cement, aggregates, water and optional admixtures. A critical performance requirement is the ability of the freshly sprayed material to rapidly set and adhere to vertical and overhead substrates and ensure early strength development. To achieve these requirements, chemical accelerators are commonly incorporated into the shotcrete mixture. A wide variety of accelerators have been developed to accelerate the cement hydration reaction. Sodium silicate is a historical accelerator but can cause long-term strength regression, alkali-silicate reaction with aggregate, and efflorescence related to free alkalinity.

Portland-limestone cement (1L), Portland cement, pozzolanic material, and limestone (1T) and Portland-pozzolanic cement (1P) are gaining popularity and acceptance as low carbon alternatives to sprayed concrete produced using traditional Portland cement. Alternatively, traditional Portland cement or 1L cement is used to make the shotcrete mix with a supplementary cementitious material (SCM) being added during the preparation of the blend. However, integrating these cements into shotcrete formulations introduces technical challenges, particularly concerning the choice of accelerator. The change in chemical reactivity of these cements can compromise the effectiveness of conventional alkali-free accelerators, leading to delayed setting, insufficient early strength gain, or inconsistent behavior. The increasing presence of SCMs makes it desirable to have an accelerator that will react with cement and SCM. For this reason, there is more interest in revisiting the use of sodium silicate. Ideally, an improvement in silicate chemistry would allow for quicker set times and development of early strength to allow for safer and more productive environments.

### SUMMARY

The present disclosure relates to silicate-based accelerators enriched with aluminum-based compounds, as well as to methods of making and using such accelerators in construction and/or mining applications. Specifically, embodiments involve aluminum modified silicate accelerators designed to enhance the performance of shotcrete. These accelerators build upon conventional sodium silicate chemistry by incorporating reactive aluminum end-groups, resulting in improved setting behavior and strength development.

The invention addresses the need for more effective accelerators that can deliver rapid early strength gain while maintaining or improving long-term durability, especially when used with modern cement blends. Unlike traditional sodium silicate-based accelerators, the aluminum-modified silicate provides enhanced reactivity and mechanisms for cement hydration, leading to superior performance in challenging formulations.

In an exemplary embodiment, an accelerator for use in a shotcrete mixture comprises a soluble hydrated alkali silicate aluminate formed from the reaction of an alkali metal silicate and an aluminum-based compound.

In some embodiments, the aluminum-based compound is selected from the group consisting of aluminum oxide, aluminum hydroxide, alkaline aluminate, aluminum sulfate, aluminum chloride, and mixtures thereof.

In some embodiments, the aluminum-based compound is aluminum oxide or aluminum hydroxide.

In some embodiments, the alkali metal silicate is selected from the group consisting of sodium silicate and potassium silicate.

In some embodiments, the alkali metal silicate is sodium silicate having a molar ratio of SiO₂:Na₂O of from 1.1 to 4.5.

In some embodiments, the alkali metal silicate is potassium silicate having a molar ratio of SiO₂:K₂O of from 1.1 to 3.0.

In some embodiments, on an aluminum oxide basis reacted onto the alkali metal silicate, the aluminum-based compound is present in an amount of from 0.1 to 5.0% by weight.

In an exemplary embodiment, a shotcrete mixture comprises the accelerator and a cement-containing composition.

In some embodiments, the cement-containing composition comprises a cement selected from the group consisting of a Type 1L cement, a Type 1T cement, and a Type 1P cement.

In some embodiments, the cement-containing composition includes supplementary cementitious materials selected from the group consisting of blast furnace slag, fly ash, tailings, pumice, metakaolin, and/or mixtures thereof.

In some embodiments, the cement-containing composition further comprises aggregates, water, and optionally admixtures.

In some embodiments, the shotcrete mixture has a greater strength measured within 1 hour after application to a substrate relative to a comparative shotcrete mixture including a sodium silicate accelerator.

In some embodiments, the shotcrete mixture has a greater strength measured 28 days after application to a substrate relative to a comparative shotcrete mixture including a sodium silicate accelerator.

### DETAILED DESCRIPTION

The following description is of exemplary embodiments of accelerators and methods of making and using said accelerators. This description is not to be taken in a limiting sense but is made merely for the purpose of describing the general principles and features of various aspects of the present invention. The scope of the present invention is not limited by this description.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

All references to singular characteristics or limitations of the present disclosure shall include the corresponding plural characteristic(s) or limitation(s) and vice versa, unless otherwise specified or clearly implied to the contrary by the context in which the reference is made.

As used herein (when used in this application, including the claims), the terms “a,” “an,” and “the” refer to “one or more.” The use of the word “a” or “an” when used in conjunction with the term “comprising” in the claims and/or the specification may mean “one,” but it is also consistent with the meaning of “one or more,” “at least one,” and “one or more than one.”

All combinations of method or process steps as used herein can be performed in any order, unless otherwise specified or clearly implied to the contrary by the context in which the referenced combination is made.

The methods and devices of the present disclosure, including components thereof, can comprise, consist of, or consist essentially of the essential elements and limitations of the embodiments described herein, as well as any additional or optional components or limitations described herein or otherwise useful.

As used herein, “alkali metal silicate” is a compound with a chemical formula X SiO₂:M₂O, where M is an alkali metal (e.g., lithium, sodium, potassium, etc.) and X is the molar ratio of the silicate.

As used herein, a component being “enriched” with another component may refer to the second component being added to the first component or vice versa.

As used herein, “aluminum-based compound” is a chemical substances that contain aluminum (Al) as a primary element in their structure. These compounds can include a variety of forms, such as but not limited to, oxides (e.g., aluminum oxide), hydroxides (e.g., aluminum hydroxide), and salts (e.g., aluminum sulfate).

Embodiments relate to alkali metal silicate-based accelerators enriched with one or more aluminum-based compounds. In particular, these accelerators involve the formation of hydrated silicate aluminate structures through the combination of alkali metal silicates (such as sodium silicate) and aluminum compounds. Unlike simple blending, the aluminum compounds are incorporated into the silicate structure itself, resulting in aluminum acting as a reactive end-group within the silicate network. The accelerators may desirably exhibit improved early-age and long-term performance of shotcrete mixtures when compared to shotcrete mixtures blended with other conventional accelerators, such as sodium silicate. Notably, the accelerators may exhibit improved performance with increasing limestone and SCMs content.

In particular, aluminum oxide (Al₃O₃) may serve a key role as a network-modifying agent, reacting with the silicate molecules to form more complex and robust structures. This modification enhances properties such as chemical reactivity on cement as well as supplementary cementitious material. When the hydrated sodium silicate aluminate interacts with cementitious materials, it forms a rigid, insoluble gel that effectively agglomerates particles, thereby improving the mixture's water resistance, chemical durability, and overall resilience against environmental exposure.

It is understood that the hydrated silicate aluminate structures are soluble in water and are therefore distinguished from, e.g., an aluminosilicate mineral with associated water. The hydrated silicate aluminate structures may therefore be provided as an aqueous solution

The aluminum-based compounds may be selected from the group consisting of aluminum oxide (Al₂O₃), aluminum hydroxide (Al(OH)₃), alkaline aluminate (MAlO₂, wherein Mis an alkali metal such as sodium), aluminum sulfate (Al₂(SO₄)₃), aluminum chloride (AlCl₃), and/or mixtures thereof. In some embodiments, the aluminum-based compounds are aluminum oxide or aluminum hydroxide.

The alkali metal silicate may be selected from the group consisting of sodium silicate (SiO₂:Na₂O), potassium silicate (SiO₂:K₂O), and mixtures thereof.

In embodiments including sodium silicate, the sodium silicate may have a molar ratio of SiO₂:Na₂O of from 1.1 to 4.5. As nonlimiting examples, the sodium silicate may have a molar ratio of SiO₂:Na₂O of at least 1.1, at least 1.5, at least 2.0, at least 2.5, at least 3.0, at least 3.5, at least 4.0, and/or the like. As further nonlimiting examples, the sodium silicate may have a molar ratio of SiO₂:Na₂O of no greater than 4.5, no greater than 4.0, no greater than 3.5, no greater than 3.0, no greater than 2.5, no greater than 2.0, no greater than 1.5, and/or the like.

In embodiments including potassium silicate, the potassium silicate may have a molar ratio of SiO₂:K₂O of from 1.1 to 3.0. As nonlimiting examples, the sodium silicate may have a molar ratio of SiO₂:K₂O of at least 1.1, at least 1.5, at least 2.0, at least 2.5, and/or the like. As further nonlimiting examples, the sodium silicate may have a molar ratio of SiO₂:K₂O of no greater than 3.0, no greater than 2.5, no greater than 2.0, no greater than 1.5, and/or the like.

Table 1 lists exemplary aqueous alkali silicates made by PQ Corporation that may be utilized in the accelerators described herein. The scope of the present disclosure is by no means limited to these examples.

TABLE 1

| | | | | |
|---|---|---|---|---|
| Product | | | | |
| Name | SiO₂/M₂O | % SiO₂ | % M₂O | % Solids |

Potassium Silicates

| | | | | | |
|---|---|---|---|---|---|
| KASIL ® 1 | 2.5 | 20.8 | 8.3 | 29.1 | Liquid |
| KASIL ® 6 | 2.1 | 26.5 | 12.65 | 39.15 | Liquid |
| EcoDrill ® | 3.0 | 18.0 | 6.0 | 24.0 | Liquid |
| K45 | | | | | |
| BW ™ 50 | 1.60 | 26.2 | 16.75 | 42.55 | Liquid |
| BJ ™ 120 | 1.80 | 23.7 | 13.15 | 36.85 | Liquid |
| D ™ | 2.00 | 29.4 | 14.7 | 44.1 | Liquid |
| RU ™ | 2.40 | 33.0 | 13.9 | 47.1 | Liquid |
| M ® | 2.58 | 32.1 | 12.4 | 44.5 | Liquid |
| K ® | 2.88 | 31.7 | 11.0 | 42.7 | Liquid |
| N ® | 3.22 | 28.7 | 8.9 | 37.6 | Liquid |
| N38 ® | 3.22 | 26.4 | 8.2 | 34.6 | Liquid |
| EcoDrill S45 | 4.4 | 21.1 | 4.8 | 25.9 | Liquid |

Other Silicates

| | | | | | |
|---|---|---|---|---|---|
| Lithisil ® 25 | 8.2 | 20.5 | 2.5 | 23.0 | Liquid |
| | | | | | lithium |
| | | | | | silicate |

The accelerators may include any relative amount of alkali metal silicates and aluminum-based compounds.

In some embodiments, the accelerators may include at least 0.1% by weight and no greater than 5.0% by weight of the aluminum-based compounds, based on an aluminum oxide basis reacted onto the alkali metal silicates.

As nonlimiting examples, the accelerators may include at least 0.1% by weight, at least 0.5% by weight, at least 1.0% by weight, at least 1.5% by weight, at least 2.0% by weight, at least 2.5% by weight, at least 3.0% by weight, at least 3.5% by weight, at least 4.0% by weight, at least 4.5% by weight, and/or the like, of aluminum-based compounds. As further nonlimiting examples, the accelerator may include no greater than 5.0% by weight, no greater than 4.5% by weight, no greater than 4.0% by weight, no greater than 3.5% by weight, no greater than 3.0% by weight, no greater than 2.5% by weight, no greater than 2.0% by weight, no greater than 1.5% by weight, no greater than 1.0% by weight, no greater than 0.5% by weight and/or the like, of aluminum-based compounds.

Embodiments may also relate to shotcrete mixtures including accelerators described herein. In particular, a shotcrete mixture can include a cement, aggregates, water, and optionally admixtures. The components can be mixed to form cement-containing compositions, which may subsequently be mixed prior to application (e.g., at the nozzle) with the accelerators to form the shotcrete mixtures.

The cement can include Portland cement, limestone, pozzolanic materials, supplementary cementitious materials (SCMs), and/or mixtures thereof. In some embodiments, the cement-containing composition can be one of a Type 1L cement, a Type 1T cement, or a Type 1P cement.

The SCMs may include, but are not limited to, ground granulated blast furnace slag, fly ash (types C and F), tailings, natural pozzolans, such as pumice and metakaolin, and/or mixtures thereof.

In some embodiments, the shotcrete mixture may include at least 1.0% by weight and no greater than 15.0% by weight, particularly at least 3.0% by weight and no greater than 12.0% by weight, of the accelerator based on weight of binder (i.e., cement and supplementary cementitious material).

Due to incorporation of the accelerators, shotcrete mixtures described herein may have improved properties over conventional sodium silicate accelerators, such as early strength development (e.g., strength measured within 1 hour after application) while maintaining or improving long-term strength (e.g., strength measured 28 days after application).

### EXAMPLES

A range of aluminum modified silicates were produced and measured against sodium silicates of closely matching ratios of SiO₂:Na₂O. Performance was also benchmarked against a commercially available alkali-free accelerator composed of 48% aluminum sulfate. Also run as a control was sodium aluminate. Table 2 provides a summary of tested accelerators with the weight % of components.

TABLE 2

| | Aluminum | | | | |
|---|---|---|---|---|---|
| | Sulfate | SiO₂ | Na₂O | Al₂O₃ | % |
| | Wt. % | wt. % | Wt. % | Wt. % | solids |
| Commercial Alkali-free | 48 | 0 | 0 | 0 | 48 |
| accelerator | | | | | |
| 3.2 ratio N ® grade | 0 | 28.7 | 8.9 | 0 | 37.6 |
| 3.2 ratio + Al | 0 | 28.7 | 8.9 | 0.17 | 37.8 |
| 1.6 ratio | 0 | 25.3 | 15.8 | 0 | 41.1 |
| 1.7 ratio + Al | 0 | 26.9 | 15.8 | 1.64 | 44.3 |
| 1.36 ratio | 0 | 23.3 | 17.1 | 0 | 44.1 |
| 1.36 ratio + Al | 0 | 23.1 | 16.95 | 4.07 | 44.1 |

### Example 1

Baseline performance was set by evaluating a range of alkali silicates including aluminum-modified sodium silicate as well as a commercially available alkali-free (AF) accelerator based on 48% aluminum sulfate. A readily available Ordinary Portland Cement containing limestone (Type 1L) was used to measure baseline performance. Cement paste samples were prepared by thoroughly mixing a commercially available Type 1L cement, water and a high-range water-reducing agent using an overhead propeller mixer. Water-to-binder ratio was kept at 0.3. Table 3 shows the formulation.

TABLE 3

| Cement paste | Weight | |
|---|---|---|
| Type 1Lcement | 150 | g |
| Water | 45 | g |
| Superplasticiser | 1.5 | g |
| Accelerator | 10.5 | g |

An accelerator dosage of 7% by binder weight was added into the homogeneous cement paste under continuous mixing. Early-age strength development within the first hour was determined using a penetrometer. Table 4 shows early-age strength development and the advantage of aluminum modified silicate vs. conventional silicate at similar ratios of (SiO₂:Na₂O).

TABLE 4

| | | | | | | | 1.36 |
|---|---|---|---|---|---|---|---|
| | | | | | 1.7 | | ratio + |
| | | | 3.2 | | ratio + | | Al |
| | Alkali | 3.2 | ratio + | 1.6 | Al | 1.36 | (super |
| | Free | ratio | Al | ratio | (AAAS) | ratio | AAAS) |
| 5 min (kPa) | 29 | 78 | 137 | 29 | 29 | 39 | 88 |
| 10 min (kPa) | 59 | 137 | 206 | 137 | 127 | 167 | 235 |
| 20 min (kPa) | 69 | 196 | 235 | 235 | 353 | 324 | 304 |
| 30 min (kPa) | 69 | 255 | 324 | 392 | 481 | 451 | 412 |
| 45 min (kPa) | 88 | 343 | 402 | >600 | >600 | 539 | 579 |
| 60 min (kPa) | 137 | 392 | 559 | | | >600 | >600 |

Note:
600 kPa is the upper detection limit of the soil penetrometer.

### Example 2

To simulate shotcrete blends high in Supplementary Cementitious Material, different SCM replaced cement on a weight basis at loadings. Examples show the upper end of cement replacement with 75% by weight of the cement replaced with SCM.

Examples looked at a SCM high in CaO (e.g. ground granulated blast furnace slag-grade 100) and low in CaO (e.g. metakaolin). Accelerator dosage was set at 4% and 7% based on weight of cement+SCM.

Sample preparation and testing was similar to Example 1 with a portion of cement replaced with metakaolin. An accelerator dosage of 4% and 7% by binder weight was added into the homogeneous cement paste under continuous mixing. Early-age strength development within the first hour was measured using a penetrometer. Table 5 shows the presence of aluminum causes quicker early-age strength development in the critical first hour.

TABLE 5A
75:25 metakaolin:cement with 7% accelerator

| 1 L cement (g) | 37.5 | 37.5 | 37.5 | 37.5 | 37.5 | 37.5 | 37.5 | 37.5 |
|---|---|---|---|---|---|---|---|---|
| Metakaolin (g) | 112.5 | 112.5 | 112.5 | 112.5 | 112.5 | 112.5 | 112.5 | 112.5 |
| superplasticizer (g) | 1.45 | 1.45 | 1.45 | 1.45 | 1.45 | 1.45 | 1.45 | 1.45 |
| water (ml) | 75 | 75 | 75 | 75 | 75 | 75 | 75 | 75 |
| water/solids | 0.5 | 0.5 | 0.5 | 0.5 | 0.5 | 0.5 | 0.5 | 0.5 |
| | | | 3.2 | | | | 1.36 | 1.36 |
| | alkali | 3.2 | ratio + | 1.6 | 1.7 | 1.36 | ratio + | ratio + |
| Accelerator | free | ratio | Al | ratio | ratio | ratio | Al | Na2AlO2 |
| (g) | 10.5 | 10.5 | 10.5 | 10.5 | 10.5 | 10.5 | 10.5 | 10.5 |
| | | | 3.2 | | | | 1.36 | 1.36 |
| | alkali | 3.2 | ratio + | 1.6 | 1.7 | 1.36 | ratio + | ratio + |
| | free | ratio | Al | ratio | ratio | ratio | Al | Na2AlO2 |
| 5 min (kPa) | 49 | 127 | 255 | 20 | 29 | 0 | 0 | 0 |
| 10 min (kPa) | 118 | 211 | 265 | 20 | 39 | 0 | 0 | 0 |
| 15 min (kPa) | 157 | 226 | 314 | 29 | 59 | 0 | 0 | 0 |
| 20 min (kPa) | 186 | 294 | 490 | 69 | 69 | 0 | 10 | 10 |
| 30 min (kPa) | 265 | 412 | >600 | 167 | 137 | 10 | 49 | 39 |
| 45 min (kPa) | 363 | >600 | | 304 | 324 | 59 | 172 | 49 |
| 1 hr (kPa) | 451 | | | 431 | 481 | 74 | 226 | 59 |

TABLE 5B
75:25 metakaolin:cement with 4% accelerator

| 1 L cement (g) | 37.5 | 37.5 | 37.5 | 37.5 | 37.5 | 37.5 | 37.5 | 37.5 |
|---|---|---|---|---|---|---|---|---|
| Metakaolin (g) | 112.5 | 112.5 | 112.5 | 112.5 | 112.5 | 112.5 | 112.5 | 112.5 |
| superplasticizer (g) | 1.45 | 1.45 | 1.45 | 1.45 | 1.45 | 1.45 | 1.45 | 1.45 |
| water (ml) | 75 | 75 | 75 | 75 | 75 | 75 | 75 | 75 |
| w/c | 0.5 | 0.5 | 0.5 | 0.5 | 0.5 | 0.5 | 0.5 | 0.5 |
| | | | 3.2 | | 1.7 | | 1.36 | 1.36 |
| | alkali | 3.2 | ratio + | 1.6 | ratio + | 1.36 | ratio + | ratio + |
| Accelerator | free | ratio | Al | ratio | Al | ratio | Al | aluminate |
| (g) | 6 | 6 | 6 | 6 | 6 | 6 | 6 | 6 |
| 5 min (kPa) | 38 | 54 | 125 | 22 | 22 | 0 | 0 | 0 |
| 10 min (kPa) | 93 | 147 | 158 | 27 | 38 | 0 | 0 | 0 |
| 15 min (kPa) | 109 | 147 | 153 | 33 | 54 | 0 | 25 | 10 |
| 20 min (kPa) | 120 | 185 | 202 | 87 | 87 | 25 | 39 | 25 |
| 30 min (kPa) | 185 | 321 | 365 | 125 | 169 | 88 | 93 | 74 |
| 45 min (kPa) | 191 | 507 | 534 | 153 | 300 | 172 | 196 | 172 |
| 1 hr (kPa) | 234 | >600 | >600 | 262 | 430 | 270 | 333 | 441 |

### Example 3

Sample preparation and testing was similar to Example 1 with a portion of cement replaced with Grade 100 Ground Granulated Blast Furnace slag. An accelerator dosage of 4% and 7% by binder weight was added into the homogeneous cement paste under continuous mixing. Early-age strength development within the first hour was measured using a penetrometer.

TABLE 6A
75:25 slag:cement with 7% accelerator

| cement | 37.5 | 37.5 | 37.5 | 37.5 | 37.5 | 37.5 | 37.5 |
|---|---|---|---|---|---|---|---|
| slag 100 | 112.5 | 112.5 | 112.5 | 112.5 | 112.5 | 112.5 | 112.5 |
| water | 45 | 45 | 45 | 45 | 45 | 45 | 45 |
| superplasticizer | 1.45 | 1.45 | 1.45 | 1.45 | 1.45 | 1.45 | 1.45 |
| | | | 3.2 | | 1.7 | | 1.36 |
| | alkali | 3.2 | ratio + | 1.6 | ratio + | 1.36 | ratio + |
| | Free | ratio | Al | ratio | Al | ratio | Al |
| Accelerator | 10.5 | 10.5 | 10.5 | 10.5 | 10.5 | 10.5 | 10.5 |
| Dosage (g) | | | | | | | |
| 5 min (kPa) | 49 | 123 | 226 | 0 | 59 | 25 | 98 |
| 10 min (kPa) | 74 | 255 | 441 | 29 | 88 | 74 | 196 |
| 15 min (kPa) | 98 | 431 | 539 | 69 | 118 | 123 | 294 |
| 20 min (kPa) | 127 | 569 | >600 | 78 | 206 | 221 | 392 |
| 30 min (kPa) | 137 | 588 | | 123 | 353 | 343 | 441 |
| 45 min (kPa) | 177 | >600 | | 172 | 588 | 441 | 539 |
| 60 min (kPa) | 206 | | | 275 | >600 | >600 | >600 |

TABLE 6B
75:25 slag:cement with 4% accelerator

| cement | 37.5 | 37.5 | 37.5 | 37.5 | 37.5 | | 37.5 |
|---|---|---|---|---|---|---|---|
| slag 100 | 112.5 | 112.5 | 112.5 | 112.5 | 112.5 | | 112.5 |
| water | 45 | 45 | 45 | 45 | 45 | | 45 |
| SP | 1.45 | 1.45 | 1.45 | 1.45 | 1.45 | | 1.45 |
| | | | 3.2 | | 1.7 | | 1.36 |
| | alkali | 3.2 | ratio + | 1.6 | ratio + | 1.36 | ratio + |
| | free | ratio | A1 | ratio | Al | ratio | Al |
| accelerator (g) | 6.0 | 6.0 | 6.0 | 6.0 | 6.0 | 6.0 | 6.0 |
| 5 min (kPa) | 39 | 118 | 127 | 25 | 59 | 24.5 | 98.1 |
| 10 min (kPa) | 59 | 196 | 157 | 59 | 88 | 49.0 | 147.1 |
| 15 min (kPa) | 78 | 275 | 255 | 147 | 137 | 73.5 | 171.6 |
| 20 min (kPa) | 98 | 324 | 304 | 167 | 196 | 98.1 | 196.1 |
| 30 min (kPa) | 108 | 373 | 402 | 275 | 275 | 122.6 | 294.2 |
| 45 min (kPa) | 147 | 461 | 500 | 324 | 353 | 147.1 | 416.8 |
| 60 min (kPa) | 177 | 569 | >600 | 422 | 461 | 196.1 | 441.3 |

Although the description above contains specificities of the technology, they should not be interpreted as limitations to the scope of this invention, but as an example of a preferred embodiment. The scope of the present invention must be determined by the embodiments illustrated, but with the set of claims and its legal equivalents.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatus and methods of using and making the same disclosed herein have been discussed and illustrated, it is to be distinctly understood that the invention is not limited thereto but may be otherwise variously embodied and practiced within the scope of the following claims.

What is claimed is:

1. An accelerator for use in a shotcrete mixture, the accelerator comprising a soluble hydrated alkali silicate aluminate formed from the reaction of:
an alkali metal silicate, and
an aluminum-based compound.

2. The accelerator of claim 1, wherein the aluminum-based compound is selected from the group consisting of aluminum oxide, aluminum hydroxide, alkaline aluminate, aluminum sulfate, aluminum chloride, and mixtures thereof.

3. The accelerator of claim 2, wherein the aluminum-based compound is aluminum oxide or aluminum hydroxide.

4. The accelerator of claim 1, wherein the alkali metal silicate is selected from the group consisting of sodium silicate and potassium silicate.

5. The accelerator of claim 4, wherein the alkali metal silicate is sodium silicate having a molar ratio of SiO₂:Na₂O of from 1.1 to 4.5.

6. The accelerator of claim 4, wherein the alkali metal silicate is potassium silicate having a molar ratio of SiO₂:K₂O of from 1.1 to 3.0.

7. The accelerator of claim 1, wherein, on an aluminum oxide basis reacted onto the alkali metal silicate, the aluminum-based compound is present in an amount of from 0.1 to 5.0% by weight.

8. A shotcrete mixture comprising:
the accelerator according to claim 1; and
a cement-containing composition.

9. The shotcrete mixture of claim 8, wherein the cement-containing composition comprises a cement selected from the group consisting of a Type 1L cement, a Type 1T cement, and a Type 1P cement.

10. The shotcrete mixture of claim 9, wherein the cement-containing composition includes supplementary cementitious materials selected from the group consisting of blast furnace slag, fly ash, tailings, pumice, metakaolin, and/or mixtures thereof.

11. The shotcrete mixture of claim 9, wherein the cement-containing composition further comprises aggregates, water, and optionally admixtures.

12. The shotcrete mixture of claim 8, wherein the shotcrete mixture has a greater strength measured within 1 hour after application to a substrate relative to a comparative shotcrete mixture including a sodium silicate accelerator.

13. The shotcrete mixture of claim 8, wherein the shotcrete mixture has a greater strength measured 28 days after application to a substrate relative to a comparative shotcrete mixture including a sodium silicate accelerator.
